(19) United States
(12) Patent Application Publication
(10) Pub. No.: US 2022/0055345 A1
(43) Pub. Date: Feb. 24, 2022

(54) LAMINATES THAT CONSIST OF METAL AND A POLYMER INTERMEDIATE LAYER MADE OF THERMOPLASTIC POLYURETHANE

(71) Applicant: BASF SE, Ludwigshafen am Rhein (DE)

(72) Inventors: Philippe Desbois, Ludwigshafen (DE); Jasmina Simon, Ludwigshafen (DE)

(21) Appl. No.: 17/274,578

(22) PCT Filed: Sep. 11, 2019
(86) PCT No.: PCT/EP2019/074259

§ 371 Date: Mar. 9, 2021

(30) Foreign Application Priority Data
Sep. 14, 2018 (EP) 18194540.3

(51) Int. Cl. B32B 15/095; C08L 75/08; C09J 7/30; C09J 7/28; C09J 175/08

(52) U.S. Cl. CPC B32B 15/095; C08L 75/08; B32B 15/20; C09J 7/28; C09J 175/08; C09J 7/30

(57) ABSTRACT

Described herein is a laminate including at least one first layer of at least one first metal and at least one further layer of a polymer composition (PC). Also described herein is a process for producing the laminate.

The present invention relates to a laminate comprising at least one first layer of at least one first metal and at least one further layer of a polymer composition (PC) and to a process for producing the laminate of the invention.

A commonly encountered task in recent times is the provision of novel materials which are lighter than the materials used to date, especially for aircraft construction, automobile manufacture and boatbuilding. At the same time, these novel materials shall have the same mechanical properties, especially strength, stiffness and stability, as the known materials or even improve upon these. The novel materials shall moreover be formable by known processes, for example by deep drawing, rolling, bending, stamping or seaming.

WO 2005/014278 describes laminates comprising an adhesive polymer layer between two outer metal layers. This polymer layer comprises a nylon-6, nylon-6,6, nylon-11, nylon-12, nylon-4,6, nylon-6,10 or nylon-6,12 and a copolymer of ethylene and an unsaturated carboxylic acid and/or a carboxylic acid derivative and a reactive copolymer. The copolymer of ethylene and an unsaturated carboxylic acid and/or a carboxylic acid derivative may be grafted with polar groups.

A particular disadvantage of the laminates described in WO 2005/014278 is that they have only poor tensile strength after storage in a humid environment. Furthermore, the polymer layer frequently has fluctuating moisture absorption, resulting in fluctuating bonding properties.

US 2011/0200816 describes laminates comprising two metal layers and an interposed polymer layer. The polymer layer comprises a nylon-6/6,6 copolymer, for example. Also described are various other thermoplastic polymers such as polyolefins and polyimides. The laminates described in US 2011/0200816 also exhibit only poor tensile strengths in particular after storage in a humid environment or are even destroyed to the point of being unusable by atmospheric humidity.

DE 10 2011 084519 describes sealing layers for solar cells which comprise a first outer layer, an intermediate layer and a second outer layer. The layers may comprise polyamides for example nylon-6 or nylon-6,6.

It is thus an object of the present invention to provide a laminate and a process for production thereof, which has the disadvantages of the laminates described in the prior art only to a reduced degree, if at all.

This object was achieved by a laminate comprising at least one first layer of at least one first metal and at least one further layer of a polymer composition (PC) comprising at least one thermoplastic polyurethane (TPU), wherein the at least one thermoplastic polyurethane (TPU) is obtainable by polymerizing at least the following components:
(A) at least one polyether polyol,
(B) at least one polyisocyanate,
(C) at least one C₂-C₂₀ polyol.

It has been found that, surprisingly, the laminates of the invention have a particularly good modulus of elasticity and good peeling characteristics.

The present invention is more particularly elucidated hereinbelow.

Laminate

According to the invention, the laminate comprises at least one first layer of at least one first metal and at least one further layer of a polymer composition (PC).

What is meant in the context of the present invention by “at least one first layer” is either exactly one first layer or two or more first layers.

What is meant in the context of the present invention by “at least one first metal” is either exactly one first metal or a mixture of two or more first metals.

What is meant in the context of the present invention by “at least one further layer” is either exactly one further layer or two or more further layers.

The laminate preferably additionally comprises at least one second layer of at least one second metal, with the at least one first layer of at least one first metal being joined to the at least one second layer of at least one second metal via the at least one further layer of the polymer composition (PC). In such a laminate, the at least one first layer is thus followed by at least one further layer which is in turn followed by at least one second layer.

Such a laminate which comprises at least one first layer, at least one further layer and at least one second layer is also known as a “sandwich material”.

The present invention therefore also provides a laminate where the laminate further comprises at least one second layer of at least one second metal and where the at least one first layer is joined to the at least one second layer via the at least one further layer.

The at least one first metal of the at least one first layer may be identical or different to the at least one second metal of the at least one second layer. The at least one first metal of the at least one first layer is preferably identical to the at least one second metal of the at least one second layer.

The laminate comprises at least one first layer of at least one first metal. In other words the laminate comprises at least one first layer made of at least one first metal.

The at least one first layer of at least one first metal has a thickness for example in the range from 0.1 to 0.6 mm, preferably in the range from 0.15 to 0.4 mm and especially preferably in the range from 0.18 to 0.3 mm.

The present invention therefore also provides a laminate where the at least one first layer has a thickness in the range from 0.1 to 0.6 mm.

The laminate preferably further comprises at least one second layer of at least one second metal. In other words the laminate preferably further comprises at least one second layer made of at least one second metal.

The at least one second layer of at least one second metal has a thickness for example in the range from 0.1 to 0.6 mm, preferably in the range from 0.15 to 0.4 mm and especially preferably in the range from 0.18 to 0.3 mm.

The present invention therefore also provides a laminate where the laminate further comprises at least one second layer of at least one second metal, wherein the at least one second layer has a thickness in the range from 0.1 to 0.6 mm.

The thickness of the at least one second layer may be identical or different to the thickness of the at least one first layer. The thickness of the at least one second layer is preferably identical to the thickness of the at least one first layer.

Suitable as the at least one first metal of the at least one first layer are any metals and metal alloys known to those skilled in the art which are solid at the production temperatures and the use temperatures of the laminate. The at least one first metal of the at least one first layer is preferably selected from the group consisting of iron, aluminum, copper, nickel and magnesium and also alloys thereof. The at least one first metal is more preferably an alloy of iron, and the at least one first metal is especially preferably steel.

The present invention therefore also provides a laminate where the at least one first metal of the at least one first layer is selected from the group consisting of iron, aluminum, copper, nickel and magnesium and also alloys thereof.

The present invention therefore also provides a laminate where the at least one first metal is selected from the group consisting of iron, aluminum, copper, nickel and magnesium and also alloys thereof.

Steel is known to those skilled in the art. In the context of the present invention “steel” is understood to mean alloys comprising iron as the primary constituent. This corresponds to the definition of steel according to DIN EN 10020:2000-07.

The at least one first metal may be coated or uncoated. The at least one first metal is preferably coated. Suitable coatings for the at least one first metal are known per se to those skilled in the art and are for example adhesion promoter layers, anticorrosion layers, paint, or zinc or magnesium coatings.

The at least one first metal is preferably zinc-coated. “Zinc-coated” means that the at least one first metal is coated with a further metal, in particular with zinc or alloys of zinc.

It is therefore particularly preferable when the at least one first metal is zinc-coated steel.

The zinc-coating of the at least one first metal may be carried out by methods known to those skilled in the art, for example by hot-dip zinc coating or by galvanic zinc coating.

If the at least one first metal is zinc-coated it may further comprise further coatings, for example adhesion promoter layers and/or paint. This is known to those skilled in the art.

The coating of the at least one first metal may be carried out by any methods known to those skilled in the art, for example the coating may be effected from an aqueous solution or a dispersion.

The above-described elucidations and preferences for the at least one first metal of the at least one first layer apply correspondingly to the at least one second metal of the at least one second layer.

The present invention therefore also provides a laminate where the laminate further comprises at least one second layer of at least one second metal, wherein the at least one second metal of the at least one second layer is selected from the group consisting of iron, aluminum, copper, nickel and magnesium and also alloys thereof.

The laminate comprises at least one further layer of a polymer composition (PC). What this means, in other words, is that the at least one further layer consists of the polymer composition (PC).

The at least one further layer of a polymer composition (PC) has a thickness for example in the range from 0.02 to 1.5 mm, preferably in the range from 0.05 to 1 mm and especially preferably in the range from 0.1 to 0.5 mm.

The present invention therefore also provides a laminate where the at least one further layer has a thickness in the range from 0.02 to 1.5 mm.

The present invention also further provides a laminate where the at least one first layer has a thickness in the range from 0.1 mm to 0.6 mm and/or where the at least one further layer has a thickness in the range from 0.02 mm to 1.5 mm.

Polymer Composition (PC)

According to the invention, the polymer composition (PC) comprises at least one thermoplastic polyurethane (TPU).

What is meant by “at least one thermoplastic polyurethane (TPU)” in the context of the present invention is either exactly one thermoplastic polyurethane (TPU) or a mixture (blend) of two or more thermoplastic polyurethanes (TPUs).

In addition, the polymer composition (PC) may further comprise at least one further polymer.

What is meant by “at least one further polymer” in the context of the present invention is either exactly one further polymer or a mixture (blend) of two or more further polymers.

Polymers suitable as the at least one further polymer include any further polymers known to those skilled in the art. It will be apparent that the at least one further polymer is different than the at least one thermoplastic polyurethane (TPU).

The at least one further polymer is preferably selected from the group consisting of polyethylene and copolymers of at least two monomers selected from the group consisting of ethylene, acrylic acid, maleic anhydride, isobutylene, butene, propylene, octene, alkyl acrylate and alkyl methacrylate.

The present invention therefore also provides a laminate where the polymer composition (PC) additionally comprises at least one further polymer selected from the group consisting of polyethylene and copolymers of at least two monomers selected from the group consisting of ethylene, isobutylene, butene, propylene, octene, alkyl acrylate, alkyl methacrylate, acrylic acid and maleic anhydride.

Alkyl acrylates are known to those skilled in the art and are also referred to as “acrylic acid alkyl esters”. Alkyl acrylates are formed in the reaction of acrylic acid with an alkyl alcohol. Preference is given in accordance with the invention to n-butyl acrylate as alkyl acrylate.

Alkyl methacrylates are likewise known to those skilled in the art and are also referred to as “methacrylic acid alkyl esters”. Alkyl methacrylates are obtainable, for example, by reacting methacrylic acid with an alkyl alcohol. Alkyl methacrylates may also be substituted, for example. One example of substituted alkyl methacrylates is 2,3-epoxypropyl methacrylate. 2,3-Epoxypropyl methacrylate is also known as “glycidyl methacrylate”. Preferably in accordance with the invention, alkyl methacrylate is selected from the group consisting of methyl methacrylate and 2,3-epoxypropyl methacrylate.

In addition, the polymer composition (PC) may additionally comprise at least one filler.

What is meant by “at least one filler” in the context of the present invention is either exactly one filler or else a mixture of two or more fillers.

Suitable fillers include all fillers that are known to the person skilled in the art and can be mixed with components (A), (B) and (C), and optionally the at least one further polymer in the polymer composition (PC).

It is preferable when the at least one filler is selected from the group consisting of inorganic fillers, organic fillers and natural fillers.

The at least one filler is typically particulate. For example, the at least one filler may be a fibrous material or take the form of spheres, for example. The at least one filler has, for example, an aspect ratio in the range from 1 to 15, preferably in the range from 1 to 10 and especially preferably in the range from 1 to 5. What is meant by the “aspect ratio” in the context of the present invention is the ratio of the greatest dimension of a particle of the at least one filler to the smallest dimension of a particle of the at least one filler.

In the context of the present invention, “fiber materials” is understood to mean all materials comprising fibers, for example individual fibers, fiber bundles (rovings), nonwoven fabrics, laid scrims, woven fabrics or knitted fabrics.

For example, the at least one filler is therefore selected from the group consisting of wollastonite, talc, boron fiber materials, glass fiber materials, carbon fiber materials, silica fiber materials, ceramic fiber materials, basalt fiber materials, metal fiber materials, aramid fiber materials, poly(p-phenylene-2,6-benzobisoxazole) fiber materials, polyester fiber materials, nylon fiber materials, polyethylene fiber materials, wood fiber materials, flax fiber materials, hemp fiber materials, coconut fiber materials and sisal fiber materials.

It is particularly preferable when the at least one filler is selected from the group consisting of glass fiber materials, carbon fiber materials, aramid fiber materials, poly(p-phenylene-2,6-benzobisoxazole) fiber materials, boron fiber materials, metal fiber materials, and potassium titanate fiber materials. It is especially preferable when the at least one filler is a glass fiber material.

The polymer composition (PC) preferably does not comprise any filler.

The polymer composition (PC) comprises, for example, in the range from 0% to 50% by weight, preferably in the range from 5% to 50% by weight and especially preferably in the range from 10% to 30% by weight of the at least one further polymer, based in each case on the sum total of the percentages by weight of the at least one thermoplastic polyurethane (TPU), of the at least one further polymer and of any at least one filler, preferably based on the total weight of the polymer composition (PC).

The polymer composition (PC) comprises, for example, in the range from 0.1% to 70% by weight of the at least one filler, preferably in the range from 0.5% to 60% by weight and especially preferably in the range from 1% to 50% by weight of the at least one filler, based in each case on the sum total of the percentages by weight of the at least one thermoplastic polyurethane (TPU), of the at least one filler and of any at least one further polymer, preferably based on the total weight of the polymer composition (PC).

The sum total of the percentages by weight of the thermoplastic polyurethane (TPU), of any at least one further polymer and of any at least one filler is typically 100% by weight.

In addition, the polymer composition (PC) may comprise additives known to those skilled in the art. Additives which may be present in the polymer composition (PC) are selected, for example, from the group consisting of stabilizers, dyes, antistats, filler oils, surface improvers, siccatives, demolding aids, release agents, antioxidants, light stabilizers, PVC stabilizers, lubricants, flame retardants, blowing agents, impact modifiers, adhesion promoters, coupling agents and nucleating aids.

The present invention therefore also provides a laminate where the polymer composition (PC) additionally comprises at least one additive selected from the group consisting of stabilizers, dyes, antistats, filler oils, surface improvers, siccatives, demolding aids, release agents, antioxidants, light stabilizers, PVC stabilizers, lubricants, flame retardants, blowing agents, impact modifiers, adhesion promoters, coupling agents and nucleating aids.

These additives are known per se to the person skilled in the art. Coupling agents are also known as “crosslinking agents”. In the context of the present invention, “adhesion promoters” are understood to mean additives which further improve the adhesion of the polymer composition (PC) of the at least one further layer to the at least one first layer and optionally to the at least one second layer.

It will be apparent that, when the polymer composition (PC) additionally comprises additives, the sum total of the percentages by weight of the thermoplastic polyurethane (TPU), of the additives, of any at least one further polymer and of any at least one filler is typically 100% by weight.

The polymer composition (PC) typically has a modulus of elasticity in the range from 800 to 1400 MPa, preferably in the range from 900 to 1350 MPa and especially preferably in the range from 1000 to 1300 MPa, determined to ISO 527-1:2012.

Thermoplastic Polyurethane (TPU)

According to the invention, the polymer composition (PC) comprises at least one thermoplastic polyurethane obtainable by polymerizing at least the following components:
(A) at least one polyether polyol,
(B) at least one polyisocyanate,
(C) at least one C₂-C₂₀ polyol.

For example, the at least one thermoplastic polyurethane (TPU) is obtainable by polymerizing in the range from 5% to 50% by weight of component (A), in the range from 20% to 80% by weight of component (B) and in the range from 5% to 40% by weight of component (C), based in each case on the sum total of the percentages by weight of components (A), (B) and (C).

The at least one thermoplastic polyurethane (TPU) is preferably obtainable by polymerizing in the range from 10% to 40% by weight of component (A), in the range from 40% to 70% by weight of component (B) and in the range from 8% to 30% by weight of component (C), based in each case on the sum total of the percentages by weight of components (A), (B) and (C).

The at least one thermoplastic polyurethane (TPU) is more preferably obtainable by polymerizing in the range from 14% to 35% by weight of component (A), in the range from 50% to 65% by weight of component (B) and in the range from 13% to 24% by weight of component (C), based in each case on the sum total of the percentages by weight of components (A), (B) and (C).

The present invention therefore also provides a laminate in which the thermoplastic polyurethane (TPU) is obtainable by polymerizing in the range from 5% to 50% by weight of component (A), in the range from 20% to 80% by weight of component (B) and in the range from 5% to 40% by weight of component (C), based in each case on the sum total of the percentages by weight of components (A), (B) and (C).

It will be apparent that the percentages by weight of components (A), (B) and (C) relate to the percentages by weight prior to the polymerization of components (A), (B) and

(C). During the polymerization, the percentages by weight may possibly change. This is known per se to those skilled in the art.

Components (A), (B) and (C) are elucidated in detail further down.

What is meant by “at least one thermoplastic polyurethane (TPU)” in the context of the present invention is either exactly one thermoplastic polyurethane (TPU) or a mixture (blend) of two or more thermoplastic polyurethanes (TPUs).

If the polymer composition (PC) comprises two or more thermoplastic polyurethanes (TPUs), the mixture of the two or more thermoplastic polyurethanes (TPUs) satisfies the properties described hereinafter for the at least one thermoplastic polyurethane (TPU).

In other words, in this case, the blend of the two or more thermoplastic polyurethanes (TPUs) has the properties described hereinafter. This means that, in this case, the individual thermoplastic polyurethanes (TPUs) present in the blend may also have properties at variance from the description that follows if the blend has these properties.

According to the invention, the at least one thermoplastic polyurethane (TPU) is obtainable by polymerizing components (A), (B) and (C). Component (A) is at least one polyether polyol. Therefore, the at least one thermoplastic polyurethane (TPU) is also referred to as polyether-based thermoplastic polyurethane (TPU).

The present invention therefore also provides a laminate in which the at least one thermoplastic polyurethane (TPU) is at least one polyether-based thermoplastic polyurethane (TPU).

It is preferable that no polyester is used as a component for preparation of the at least one thermoplastic polyurethane (TPU). It is especially preferable that no component that forms ester bonds in the polymerization is used.

The present invention therefore also provides a laminate in which no component that forms ester bonds in the polymerization is used in the polymerization of components (A), (B) and (C).

A thermoplastic polyurethane (TPU) which is prepared using a polyester and/or a component that forms ester bonds in the polymerization is also referred to as polyester-based thermoplastic polyurethane (TPU). The at least one thermoplastic polyurethane (TPU) is preferably not a polyester-based thermoplastic polyurethane (TPU).

The present invention therefore also provides a laminate in which the at least one thermoplastic polyurethane (TPU) is not a polyester-based thermoplastic polyurethane (TPU).

In the polymerization of components (A), (B) and (C) for preparation of the at least one thermoplastic polyurethane (TPU), it is additionally possible to use at least one further component selected from the group consisting of chain transfer agents (D), catalysts (E) and additives (F).

The present invention therefore also provides a laminate in which the at least one thermoplastic polyurethane (TPU) is obtainable by polymerizing components (A), (B) and (C), and at least one further component selected from the group consisting of chain transfer agents (D), catalysts (E) and additives (F).

Suitable chain transfer agents (D) are known as such to the person skilled in the art.

“Chain transfer agents” in the context of the present invention are understood to mean compounds having exactly one group reactive toward isocyanates. Examples of such chain transfer agents are monofunctional alcohols, monofunctional amines and monofunctional polyols. A preferred chain transfer agent is methylamine.

For example, the chain transfer agent (D) has a molecular weight in the range from 30 g/mol to 500 g/mol.

Chain transfer agents (D) are preferably used in an amount in the range from 0% to 5% by weight, preferably in the range from 0.1% to 1% by weight, based on the sum total of the percentages by weight of component (A), component (C) and component (D).

Suitable catalysts (E) are compounds known to the person skilled in the art that catalyze the reaction between the isocyanate groups (NCO groups) of component (B) and the hydroxyl groups of components (A) and (C). For example, the catalyst (E) is selected from the group consisting of tertiary amines and organic metal compounds.

Suitable tertiary amines are known to the person skilled in the art and are selected, for example, from the group consisting of triethylamine, dimethylcyclohexylamine, N-methylmorpholine, N,N-dimethylpiperazine, 2-(dimethylaminoethoxy)ethanol and diazabicyclo[2.2.2]octane.

Suitable organic metal compounds are selected, for example, from the group consisting of titanic esters, iron(III) acetylacetonate, tin diacetate, tin dioctanoate, tin dilaurate, dibutyltin diacetate and dibutyltin dilaurate.

The catalyst (E) is typically used in amounts of 0.0001% by weight to 0.1% by weight, based on 100% by weight of components (A) and (C).

Suitable additives (F) are, for example, hydrolysis stabilizers and flame retardants.

The at least one thermoplastic polyurethane (TPU) may be prepared by any process known to those skilled in the art. For example, the at least one thermoplastic polyurethane (TPU) is prepared in a continuous process such as a reactive extrusion process, a belt process, a “one-shot” process or a prepolymer process. These processes are known per se to those skilled in the art.

The at least one thermoplastic polyurethane (TPU) typically has a melting temperature (T_{M(TPU)}). The melting temperature (T_{M(TPU)}) of the at least one thermoplastic polyurethane (TPU) is, for example, in the range from 140 to 240° C., preferably in the range from 150 to 230° C. and especially preferably in the range from 170 to 220° C., determined to ISO 11357-3:2014.

The present invention therefore also provides a laminate in which the at least one thermoplastic polyurethane (TPU) has a melting temperature (T_{M(TPU)}) in the range from 140 to 240° C.

For determination of the melting temperature (T_{M(TPU)}) to ISO 11357-3:2014, the at least one thermoplastic polyurethane (TPU) is typically used in pelletized form. The pellets of the at least one thermoplastic polyurethane (TPU) in that case typically have a size in the range from 1 mm to 10 mm.

The at least one thermoplastic polyurethane (TPU) typically has a glass transition temperature (T_{G(TPU)}). The glass transition temperature (T_{G(TPU)}) is, for example, in the range from −150 to 20° C., preferably in the range from −80 to 0° C. and especially preferably in the range from −60 to −20° C., determined to ISO 11357-2:2014.

The present invention therefore also provides a laminate in which the at least one thermoplastic polyurethane (TPU) has a glass transition temperature (T_{G(TPU)}), where the glass transition temperature (T_{G(TPU)}) is in the range from −150 to 20° C.

In the context of the present invention, the glass transition temperature (T_{G(TPU)}) of the at least one thermoplastic polyurethane (TPU) is based, in accordance with ISO 11357-2:2014, on the glass transition temperature (T_{G(TPU)}) of the at least one thermoplastic polyurethane (TPU) in dry form.

In the context of the present invention, “dry” means that the at least one thermoplastic polyurethane (TPU) comprises less than 1% by weight, preferably less than 0.5% by weight and especially preferably less than 0.1% by weight of water, based on the total weight of the at least one thermoplastic polyurethane (TPU). More preferably, “dry” means that the at least one thermoplastic polyurethane (TPU) does not comprise any water, and most preferably that the at least one thermoplastic polyurethane (TPU) does not comprise any solvent.

The at least one thermoplastic polyurethane (TPU) has, for example, a modulus of elasticity in the range from 800 to 1400 MPa, preferably in the range from 900 to 1350 MPa and more preferably in the range from 1000 to 1300 MPa, determined to DIN EN ISO 527-1:2012.

The present invention therefore also provides a laminate in which the at least one thermoplastic polyurethane (TPU) has a modulus of elasticity in the range from 800 to 1400 MPa.

Component (A)

According to the invention, component (A) is at least one polyether polyol.

In the context of the present invention, the terms “component (A)” and “at least one polyether polyol” are used synonymously and therefore have the same meaning.

What is meant by “at least one polyether polyol” in the context of the present invention is either exactly one polyether polyol or a mixture of two or more polyether polyols.

“Polyether polyols” in the context of the present invention are understood to mean polyethers having two or more alcohol groups (hydroxyl groups, OH groups). Preferred polyether polyols are polyether diols. “Polyether diols” are understood to mean polyethers having exactly two alcohol groups (OH groups; hydroxyl groups). Polyether polyols are known as such to the person skilled in the art.

Preferred polyether polyols are obtainable, for example, by anionic polymerization of alkylene oxides with alkali metal hydroxides, for example sodium hydroxide or potassium hydroxide, or alkali metal alkoxides, such as sodium methoxide, sodium ethoxide or potassium ethoxide, or potassium isopropoxide, as catalysts, with addition of at least one starter molecule, where the starter molecule comprises two to three, preferably two, reactive hydrogen atoms. In addition, polyether polyols are obtainable by catalytic polymerization of alkylene oxides having two to four carbon atoms in the alkyl radical and using Lewis acids as catalysts.

Preferred alkylene oxides are selected, for example, from the group consisting of tetrahydrofuran, 1,3-propylene oxide, ethylene oxide and 1,2-propylene oxide. Particular preference is given to tetrahydrofuran, ethylene oxide and 1,2-propylene oxide. Most preferred is tetrahydrofuran.

Preferably in accordance with the invention, therefore, component (A) is selected from the group consisting of polytetrahydrofuran, polyethylene oxide and poly-1,2-propylene oxide. Preferably in accordance with the invention, component (A) is polytetrahydrofuran.

Suitable starter molecules are known as such to those skilled in the art. For example, the starter molecules are selected from the group consisting of water, ethanediol, propane-1,2-diol, butane-1,4-diol, diethylene glycol, hexane-1,6-diol and 2-methylpentane-1,5-diol.

Component (A) is preferably linear and has, for example, a number-average molecular weight (Mₙ) in the range from 100 to 8000 g/mol, preferably in the range from 200 to 7000 g/mol and more preferably in the range from 600 to 6000 g/mol.

The present invention therefore also provides a laminate in which component (A) has a number-average molecular weight (Mₙ) in the range from 100 to 8000 g/mol.

Component (B)

According to the invention, component (B) is at least one polyisocyanate.

In the context of the present invention, the terms “component (B)” and “at least one polyisocyanate” are used synonymously and therefore have the same meaning.

What is meant by “at least one polyisocyanate” in the context of the present invention is either exactly one polyisocyanate or a mixture of two or more polyisocyanates.

In the context of the present invention, a “polyisocyanate” is understood to mean compounds comprising two or more isocyanate groups. The at least one polyisocyanate is preferably an organic polyisocyanate. Further preferably, the at least one polyisocyanate is at least one diisocyanate.

Therefore, component (B) is preferably at least one organic diisocyanate. In the context of the present invention, “organic diisocyanates” are understood to mean aliphatic, cycloaliphatic, araliphatic and/or aromatic diisocyanates.

For example, component (B) is selected from the group consisting of trimethylene diisocyanate, tetramethylene diisocyanate, pentamethylene diisocyanate, hexamethylene diisocyanate, heptamethylene diisocyanate, octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate; IPDI), 1,4- and/or 1,3-bis(isocyanatomethyl)cyclohexane (HXDI), cyclohexane 1,4-diisocyanate, 1-methylcyclohexane 2,4-diisocyanate, 1-methylcyclohexane 2,6-diisocyanate, dicyclohexylmethane 4,4′-diisocyanate, dicyclohexylmethane 2,4′-diisocyanate, dicyclohexylmethane 2,2′-diisocyanate, diphenylmethane 2,2′-diisocyanate (2,2′-MDI), diphenylmethane 2,4′-diisocyanate (2,4′-MDI), diphenylmethane 4,4′-diisocyanate (4,4′-MDI), naphthylene 1,5-diisocyanate (NDI), tolylene 2,4-diisocyanate (2,4-TDI), tolylene 2,6-diisocyanate (2,6TD1), 3,3′-dimethyldiphenyl diisocyanate, diphenylethane 1,2-diisocyanate and phenylene diisocyanate.

More preferably, component (B) is selected from the group consisting of diphenylmethylene 4,4′-diisocyanate, diphenylmethane 2,4′-diisocyanate and diphenylmethane 2,2′-diisocyanate.

The present invention therefore also provides a laminate in which component (B) is selected from the group consisting of diphenylmethane 4,4′-diisocyanate, diphenylmethane 2,4′-diisocyanate and diphenylmethane 2,2′-diisocyanate.

Component (C)

Component (C) is at least one C₂-C₂₀ polyol.

In the context of the present invention, the terms “component (C)” and “at least one C₂-C₂₀ polyol” are used synonymously and therefore have the same meaning.

What is meant by “at least one C₂-C₂₀ polyol” in the context of the present invention is either exactly one C₂-C₂₀ polyol or a mixture of two or more C₂-C₂₀ polyols.

In the context of the present invention, a “C₂-C₂₀ polyol” is understood to mean a compound having two to twenty carbon atoms and at least two alcohol groups (hydroxyl groups; OH groups). Component (C) may be an aliphatic, araliphatic, aromatic and/or cycloaliphatic compound having two to twenty carbon atoms and two or more alcohol groups (OH groups; hydroxyl groups). Component (C) preferably has exactly two hydroxyl groups.

For example, component (C) is selected from the group consisting of ethylene glycol, propane-1,2-diol, propane-1,3-diol, butane-1,4-diol, hexane-1,6-diol, dialkylene glycols having three to eight carbon atoms, trialkylene glycols having three to eight carbon atoms and tetraalkylene glycols having three to eight carbon atoms.

More preferably, component (C) is selected from the group consisting of ethylene glycol, propane-1,2-diol, propane-1,3-diol and butane-1,4-diol.

The present invention therefore also provides a laminate in which component (C) is selected from the group consisting of ethylene glycol, propane-1,2-diol, propane-1,3-diol and butane-1,4-diol.

Production

The laminate of the invention may be produced by any methods known to those skilled in the art. It is preferable when the laminate is produced in a continuous process.

The laminate of the invention is preferably produced in a process comprising the steps of:
a) providing a film of a polymer composition (PC) comprising at least one thermoplastic polyurethane (TPU), where the at least one thermoplastic polyurethane (TPU) is obtainable by polymerizing at least the following components:
   (A) at least one polyether polyol,
   (B) at least one polyisocyanate,
   (C) at least one C₂-C₂₀ polyol,
b) heating a first sheet of at least one first metal,
c) pressing the heated first sheet from step b) with the film provided in step a) to obtain the laminate.

The present invention therefore also provides a process for producing a laminate of the invention, comprising the steps of
a) providing a film of a polymer composition (PC) comprising at least one thermoplastic polyurethane (TPU), where the at least one thermoplastic polyurethane (TPU) is obtainable by polymerizing at least the following components:
   (A) at least one polyether polyol,
   (B) at least one polyisocyanate,
   (C) at least one C₂-C₂₀ polyol,
b) heating a first sheet of at least one first metal,
c) pressing the heated first sheet from step b) with the film provided in step a) to obtain the laminate.

The above-described elucidations and preferences for the polymer composition (PC) of the laminate of the invention apply correspondingly to the polymer composition (PC) in the process of the invention.

The elucidations and preferences for the at least one thermoplastic polyurethane (TPU) of the laminate likewise apply correspondingly to the at least one thermoplastic polyurethane (TPU) of the process.

Step a) comprises providing a film of the polymer composition (PC). The film provided in step a) consists of the polymer composition (PC). Processes for providing a film of a polymer composition (PC) are known per se to those skilled in the art. Step a) preferably comprises providing the film by an extrusion method.

The present invention therefore also provides a process in which the film is provided in step a) by an extrusion method.

Suitable extrusion methods for providing the film of the polymer composition (PC) are known to those skilled in the art and include, for example, casting methods, calendering methods, blowing methods or multi-blowing methods.

The film of the polymer composition provided in step a) may have any desired thickness. The film of the polymer composition (PC) provided in step a) typically has a thickness in the range from 1% to 20% greater than the at least one further layer of the laminate to be produced, preferably in the range from 2% to 15% greater than the at least one further layer of the laminate to be produced and especially preferably in the range from 4% to 10% greater than the at least one further layer of the laminate to be produced.

Step b) comprises heating a first sheet of at least one first metal. The first sheet is made of the at least one first metal. The above-described details and preferences for the at least one first metal present in the laminate are correspondingly applicable to the at least one first metal. The heating of the first sheet may be effected by any method known to those skilled in the art. Step b) preferably comprises heating the first sheet by inductive means.

The present invention therefore also provides a process in which the first sheet is heated in step b) by inductive means.

Step b) may comprise heating the first sheet to any desired temperature. Step b) preferably comprises heating the first sheet to a temperature above the melting temperature (T_{M(PC)}) and below the decomposition temperature of the polymer composition (PC). Step b) preferably comprises heating the first sheet to a temperature in the range from 150 to 350° C., more preferably in the range from 180 to 280° C. and especially preferably in the range from 200 to 220° C.

The present invention therefore therefore also provides a process in which step b) comprises heating the first sheet to a temperature in the range from 150° C. to 350° C.

Step c) comprises pressing the heated first sheet from step b) with the film provided in step a) to obtain the laminate. This joins the film to the first sheet. This may reduce the thickness of the film.

Processes for pressing in step c) the heated first sheet from step b) with the film provided in step a) are known per se to those skilled in the art.

The steps b) and c) may be performed simultaneously or consecutively. It is preferable when the steps b) and c) are performed simultaneously. In that case, the first sheet is heated while being pressed with the film provided in step a).

The laminate obtained in step c) is typically cooled. Cooling can be effected by any processes known to those skilled in the art, for example by the blowing of compressed air onto the laminate. The laminate is preferably cooled while maintaining the pressing pressure.

In the laminate obtained, the heated first sheet is the at least one first layer of at least one first metal, and the film is the at least one further layer of the polymer composition (PC).

If the laminate is to comprise at least one second layer, an additional step b1) comprising heating a second sheet of at least one second metal is performed. The above-described elucidations and preferences for the heating of the first sheet in step b) apply correspondingly to the heating of the second sheet in step b1).

Step c) then comprises pressing the heated first sheet with the heated second sheet from step b1) while the film provided in step a) is disposed between the two sheets.

The process for producing the laminate of the invention then typically comprises the steps of:
a) providing a film of a polymer composition (PC) comprising at least one thermoplastic polyurethane (TPU), where the at least one thermoplastic polyurethane (TPU) is obtainable by polymerizing at least the following components:
   (A) at least one polyether polyol,
   (B) at least one polyisocyanate,
   (C) at least one C₂-C₂₀ polyol,
b) heating a first sheet of at least one first metal, b1) heating a second sheet of at least one second metal,
c) positioning the film provided in step a) between the first sheet heated in step b) and the second sheet heated in step b1) and pressing the first sheet heated in step b) and the second sheet heated in step b1) with the film provided in step a) to obtain the laminate.

The present invention therefore also provides a process for producing a laminate of the invention which additionally comprises at least one second layer of at least one second metal, and where the at least one first layer is joined to the at least one second layer via the at least one further layer, comprising the steps of
a) providing a film of a polymer composition (PC) comprising at least one thermoplastic polyurethane (TPU), where the at least one thermoplastic polyurethane (TPU) is obtainable by polymerizing at least the following components:
   (A) at least one polyether polyol,
   (B) at least one polyisocyanate,
   (C) at least one C₂-C₂₀ polyol,
b) heating a first sheet of at least one first metal, b1) heating a second sheet of at least one second metal,
c) positioning the film provided in step a) between the first sheet heated in step b) and the second sheet heated in step b1) and pressing the first sheet heated in step b) and the second sheet heated in step b1) with the film provided in step a) to obtain the laminate.

The above-described elucidations and preferences for any at least one second metal of the at least one second layer present in the laminate apply correspondingly to the at least one second metal of the second sheet in the process of the invention.

The above-described elucidations and preferences for the first sheet and the heating of the first sheet apply correspondingly to the second sheet and the heating of the second sheet.

The above-described elucidations and preferences for step c) likewise apply correspondingly to step c) in which the second sheet is additionally positioned.

The present invention is more particularly elucidated hereinbelow with reference to examples without being limited thereto.

### EXAMPLES

The following components were used:

Thermoplastic Polyurethane
TPU1: Elastollan 1174 D (thermoplastic polyurethane from BASF SE; MDI/polyetherol copolymer)
TPU2: Elastollan 1283 D11 (thermoplastic polyurethane from BASF SE; MDI/polyetherol copolymer)
TPU3: Elastollan C74 D (thermoplastic polyurethane from BASF SE; MDI/polyesterol copolymer)

First and Second Metal

Steel

Production of Laminates

The polymers specified in table 1, in the amounts specified in table 1, were compounded at 230° C. with a Haake PolyLab QC with a CTW100 extruder to obtain a polymer composition, and extruded through a slot film die of width 100 mm. The resultant strand was processed by means of a water-cooled roll of width 20 cm wide to form a film of width at least 5 mm and thickness 420 μm, and wound up. The amounts specified in table 1 are all in percent by weight.

The films of the polymer composition and the first sheet and the second sheet of the steel were dried at 80° C. and a pressure of <5 mbar for seven days prior to the production of the laminates.

The laminate was produced by inserting a first sheet of the steel and a second sheet of the steel into an apparatus. A film of the polymer composition was placed between the first sheet and the second sheet. The sheets were pressed with a hydraulic press at 250° C. and 30 bar for 60 seconds.

For cooling, the laminate was removed hot from the press and covered with a steel sheet (40×40 mm, thickness 5 mm). After cooling, the laminates were stored under air with <1% relative humidity. The specimens were measured in a Zwick tester (Zwicki BT1-FR5.0TN with pneumatic clamping jaws) in accordance with DIN EN ISO 11339, with a measurement speed of 200 mm/min and a specimen thickness of 0.85 to 0.9 mm. The tensile force in newtons (N) ascertained from the measurement distance of 100 mm is used to form the average over the entire measurement, and corrected by calculation to a width of 40 mm. The results (T-peel) for the various laminates can likewise be seen in table 1.

The modulus of elasticity of the laminates was determined to ISO 527-1:2012. The results can likewise be seen in table 1.

TABLE 1

| | | | | | Modulus of | |
|---|---|---|---|---|---|---|
| | | | | | elasticity | T-Peel |
| | | TPU1 | TPU2 | TPU3 | [MPa] | [N] |
| E1 | PC1 | 70 | 30 | | 1030 | 553 |
| E2 | PC2 | 60 | 40 | | 1150 | 456 |
| E3 | PC3 | 50 | 50 | | 1290 | 449 |
| E4 | PC4 | 40 | 60 | | 1430 | 380 |
| E5 | PC5 | 100 | | | 670 | 544 |
| C6 | PC6 | | | 100 | 660 | 337 |
| C7 | PC7 | | 50 | 50 | 1260 | 375 |
| E8 | PC8 | | 100 | | 1922 | 54 |

The laminates of the invention have particularly good peel properties and a good modulus of elasticity.

1. A laminate comprising at least one first layer of at least one first metal and at least one further layer of a polymer composition (PC) comprising at least one thermoplastic polyurethane (TPU), wherein the at least one thermoplastic polyurethane (TPU) is obtainable by polymerizing at least the following components:
(A) at least one polyether polyol,
(B) at least one polyisocyanate, and
(C) at least one C₂-C₂₀ polyol.

2. The laminate according to claim 1, wherein the laminate additionally comprises at least one second layer of at least one second metal and wherein the at least one first layer is joined to the at least one second layer via the at least one further layer.

3. The laminate according to claim 1, wherein the at least one thermoplastic polyurethane (TPU) has a glass transition temperature (T_{G(TPU)}) in the range from −150° C. to 20° C.

4. The laminate according to claim 1, wherein the thermoplastic polyurethane (TPU) is obtainable by polymerizing in the range from 5% to 50% by weight of component (A), in the range from 20% to 80% by weight of component (B) and in the range from 5% to 40% by weight of component (C), based in each case on the sum total of the percentages by weight of components (A), (B) and (C).

5. The laminate according to claim 1, wherein component (B) is selected from the group consisting of diphenylmethane 4,4′-diisocyanate, diphenylmethane 2,4′-diisocyanate and diphenylmethane 2,2′-diisocyanate.

6. The laminate according to claim 1, wherein component (C) is selected from the group consisting of ethylene glycol, propane-1,2-diol, propane-1,3-diol and butane-1,4-diol.

7. The laminate according to claim 1, wherein the at least one thermoplastic polyurethane (TPU) has a modulus of elasticity in the range from 800 to 1400 MPa.

8. The laminate according to claim 1, wherein component (A) has a number average molecular weight (Mₙ) in the range from 100 to 8000 g/mol.

9. The laminate according to claim 1, wherein the at least one first metal is selected from the group consisting of iron, aluminum, copper, nickel and magnesium and alloys thereof.

10. The laminate according to claim 1, wherein the at least one first layer has a thickness in the range from 0.1 mm to 0.6 mm and/or wherein the at least one further layer has a thickness in the range from 0.02 mm to 1.5 mm.

11. The laminate according to claim 1, wherein the polymer composition (PC) further comprises at least one additive selected from the group consisting of stabilizers, dyes, antistats, filler oils, surface improvers, siccatives, demolding agents, release agents, antioxidants, light stabilizers, PVC stabilizers, lubricants, flame retardants, blowing agents, impact modifiers, adhesion promoters, coupling agents and nucleating agents.

12. A process for producing a laminate according to claim 1, comprising the steps of
a) providing a film of a polymer composition (PC) comprising at least one thermoplastic polyurethane (TPU), where the at least one thermoplastic polyurethane (TPU) is obtainable by polymerizing at least the following components:
(A) at least one polyether polyol,
(B) at least one polyisocyanate, and
(C) at least one C₂-C₂₀ polyol,
b) heating a first sheet of at least one first metal, and
c) pressing the heated first sheet from step b) with the film provided in step a) to obtain the laminate.

13. The process according to claim 12, wherein step b) comprises heating the first sheet to a temperature in the range from 150° C. to 350° C.

14. The process according to claim 12, wherein the heating of the first sheet in step b) is effected by inductive means.

15. The process according to claim 12, wherein step a) comprises providing the film by an extrusion process.
